(19) United States
(12) Patent Application Publication
(10) Pub. No.: US 2012/0085292 A1
(43) Pub. Date: Apr. 12, 2012

(54) Collapsible bird house

(76) Inventor: Raymon W. Lush, Bloomfield, NE (US)

(21) Appl. No.: 12/924,842

(22) Filed: Oct. 6, 2010

(51) Int. Cl. A01K 31/08

(52) U.S. Cl. 119/431

(57) ABSTRACT

A collapsible bird house includes a metal mesh wall having upper and lower ends. The bird house may be a single level bird house or a multi-level bird house. When collapsed, the bird house is ideally suitable for shipment and/or storage. Multiple embodiments are disclosed.

### BACKGROUND OF THE INVENTION

1. Field of the Invention

This invention relates to a bird house and more particularly to a collapsible bird house which, when collapsed, is easier to store or ship since it occupies less space than when in its extended position. Even more particularly, the bird house of this invention is comprised of a metal mesh material which is extremely durable and which enables a person to view the activities of birds within the bird house.

2. Description of the Related Art

Most bird houses are constructed of either wood, plastic or lightweight metal. To the best of Applicant's knowledge, the bird houses of the prior art are not collapsible which makes them difficult to ship or store due to the size thereof. Further, to the best of Applicant's knowledge, no one has provided a bird house wherein the activity of the birds within the bird house may be viewed.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

Several versions of collapsible bird houses are disclosed. In one embodiment of the bird house of this invention, the bird house is comprised of a truncated, conical-shaped, collapsible mesh wall with upper and lower ends. The collapsible mesh wall has a bird access opening formed therein and above the lower end thereof to permit birds to pass therethrough to gain access to the interior of the mesh wall. A lower disc-shaped support plate is secured to the collapsible mesh wall which extends across the lower end thereof. A cover is secured to the mesh wall at the upper end thereof and a hanger member is provided at the upper end of the collapsible mesh wall for hanging the bird house from a support. The mesh wall has diamond-shaped openings which are large enough to permit a person to view the activity of the birds within the bird house. The collapsible mesh wall is comprised of a metal material so that it will be extremely durable in use. The bird house may be moved from its collapsed position to an extended position so that the bird house is functional.

In another embodiment of the invention, the multi-level bird house has a lower bird house portion and an upper bird house portion.

In another embodiment of the invention, the collapsible mesh wall is cylindrical in shape.

In another embodiment of the invention, the collapsible mesh wall is lantern-shaped.

It is therefore a principal object of the invention to provide an improved collapsible bird house.

A further object of the invention is to provide a collapsible bird house which may be collapsed for shipment and/or storage.

A further object of the invention is to provide a collapsible bird house which includes a collapsible metal mesh wall which defines diamond-shaped openings therein which are large enough to permit a person to view the activity of the birds within the bird house.

A further object of the invention is to provide a collapsible bird house which may be cylindrical, lantern-shaped, hourglass-shaped or truncated conical-shaped.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of the first embodiment of the bird house of this invention;

FIG. 2 is a perspective view of a second embodiment of the bird house of this invention;

FIG. 3 is a perspective view illustrating a portion of the metal mesh wall and the diamond-shaped openings defined thereby;

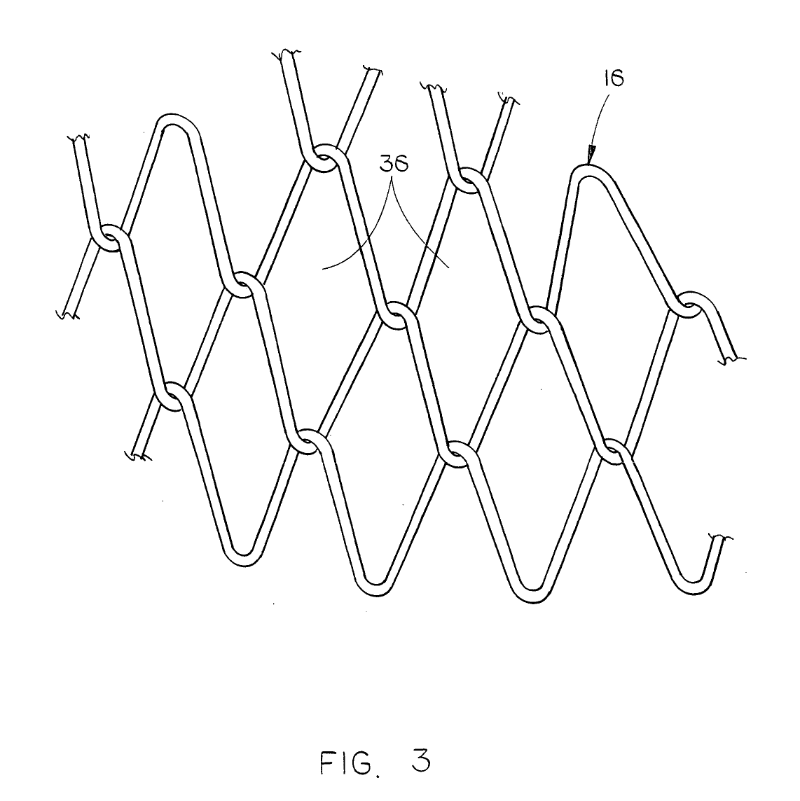

FIG. 4 is a perspective view of the bird feeder of FIG. 1 in a collapsed position;

FIG. 5 is a perspective view of a third embodiment of the bird house of this invention; and

FIG. 6 is a perspective view of the fourth embodiment of the bird house of this invention.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

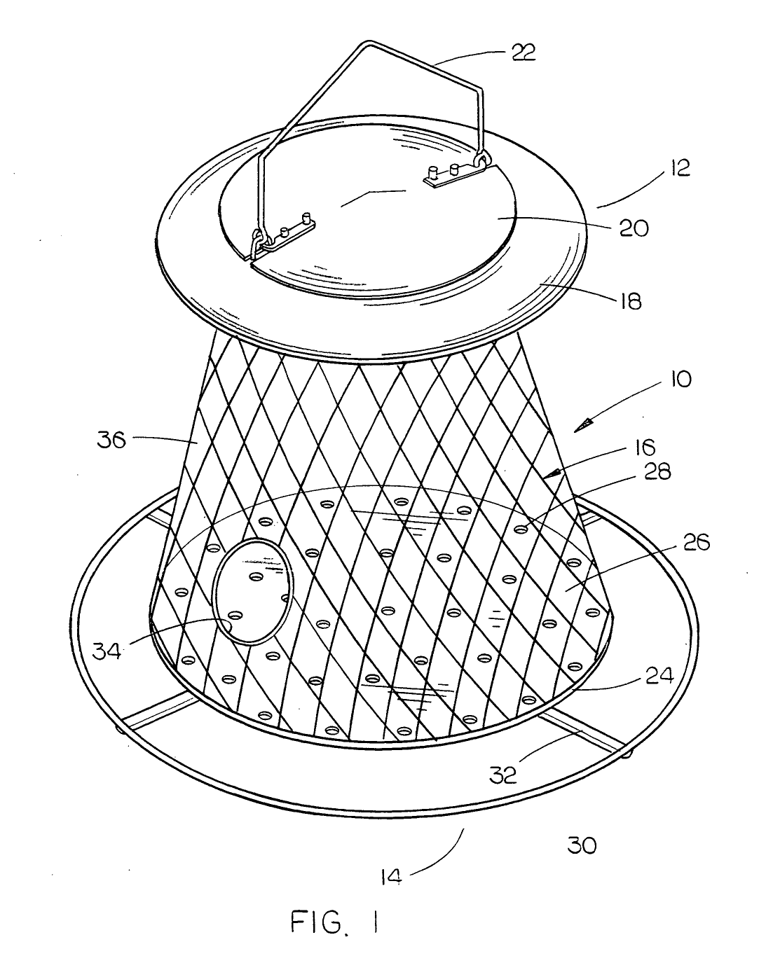

A first embodiment of the bird house of this invention is illustrated in FIG. 1 and is referred to by the reference numeral 10. For purposes of description, bird house 10 will be described as having an upper end 12 and a lower end 14. Bird house 10 includes a collapsible metal mesh wall 16 which defines a truncated, conical-shaped body portion. The composition of the collapsible mesh wall 16 is steel or other material of sufficient hardness to resist damage by squirrels or the like. Mesh wall 16 of this invention is of the type disclosed in Applicant's prior U.S. Pat. No. 6,073,582 and which is incorporated herein by reference to complete this disclosure.

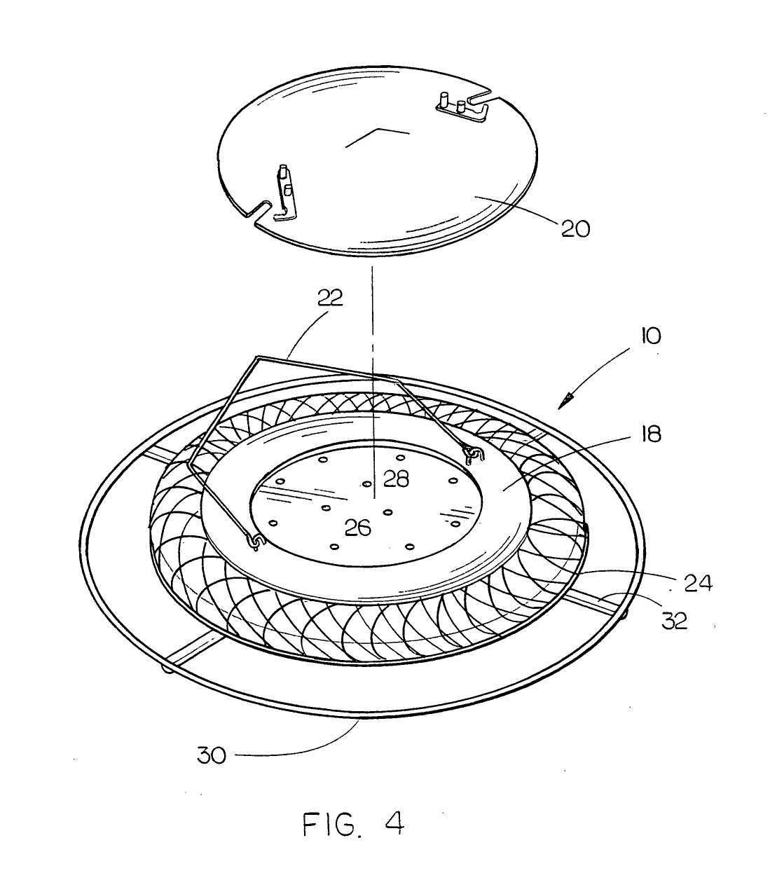

The upper end of the metal mesh wall 16 has a support 18 secured to the upper end thereof and which has an opening formed therein which is selectively closed by the cover 20. A pivotal hanger 22 extends upwardly from the support 18 for supporting the bird house 10 from a supporting object such as a branch, shepherd's hook, etc. The lower end of mesh wall 16 has a ring 24 secured thereto. A support plate 26 is supported on the ring 24 by any convenient means and has a plurality of perforations 28 formed therein for drainage purposes. A perch ring 30 is secured to the lower end of mesh wall 16 by supports 32 as seen in FIG. 1. The collapsible mesh wall 16 has a bird access opening 34 formed therein above the lower end thereof to permit the birds to enter the interior of the bird house and to exit therefrom. The metal mesh wall 16 is of the type which permits it to be collapsed, as illustrated in FIG. 4, but which normally remains in its extended position when in a hanging position. The metal mesh wall 16 has a plurality of diamond-shaped openings 26 preferably having a height of one-quarter inch and a width of three-sixteenths inch. However, the size of the openings 36 should be of such a size so that a person may view the activity of the birds within the bird house.

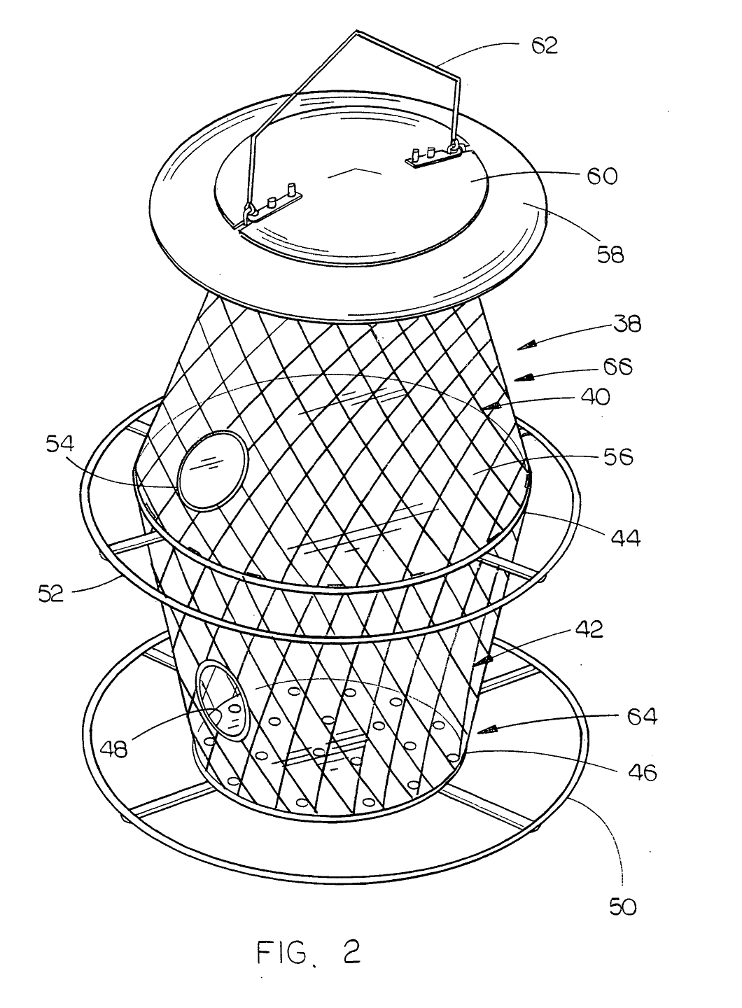

FIG. 2 illustrates a second embodiment of the bird house of this invention which is referred to generally by the reference numeral 38 and which is of the multi-level type. Bird house 38 includes a collapsible upper metal mesh wall 40 and a collapsible lower metal mesh wall 42 which are joined together by a ring 44. A perforated support plate 46 closes the lower end of lower mesh wall 42. A bird access opening 48 is formed in mesh wall 42 as seen in FIG. 2. Perch ring 50 is secured to the lower end of mesh wall 42 as seen in FIG. 2. Perch ring 52 is secured to ring 44 so as to be positioned outwardly thereof as also illustrated in FIG. 2. A bird access opening 54 is formed in upper mesh wall 40 as illustrated in FIG. 2. The lower end of upper mesh wall 40 is closed by a support plate 56.

A support plate 58 is secured to the upper end of mesh wall 40 and has a cover 60 and hanger 62 associated therewith in the same manner as in the embodiment of FIG. 1.

The bird house 38 is of the lantern-shaped style but could be of the hourglass style as well. The support plate 46 and the support plate 56 define a lower bird house portion 64. The support plate 56 and the support 58 plate define an upper bird house portion 66. Although two bird house portions are illustrated in FIG. 2, additional mesh walls could be extended downwardly from the lower end of bird house 38 if so desired. The bird house 38 may be collapsed from the extended position of FIG. 2 to a collapsed position in the same manner as the birdhouse 10.

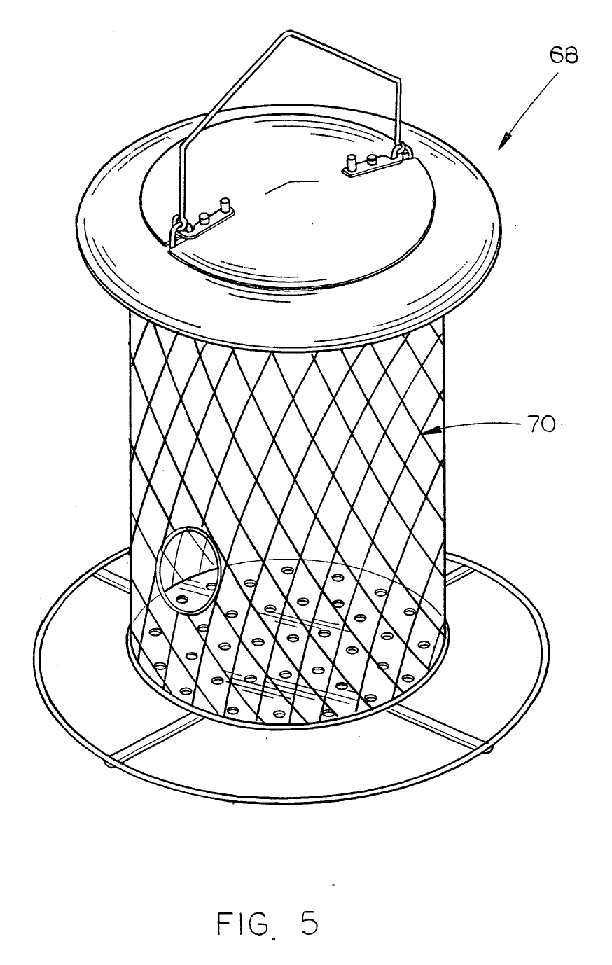

FIG. 5 illustrates a third embodiment of the bird house of this invention which is referred to generally by the reference numeral 68. Bird house 68 is identical to bird house 10 except that the collapsible metal mesh wall 70 thereof is cylindrical in shape rather than the truncated, conical-shape of the bird house 10.

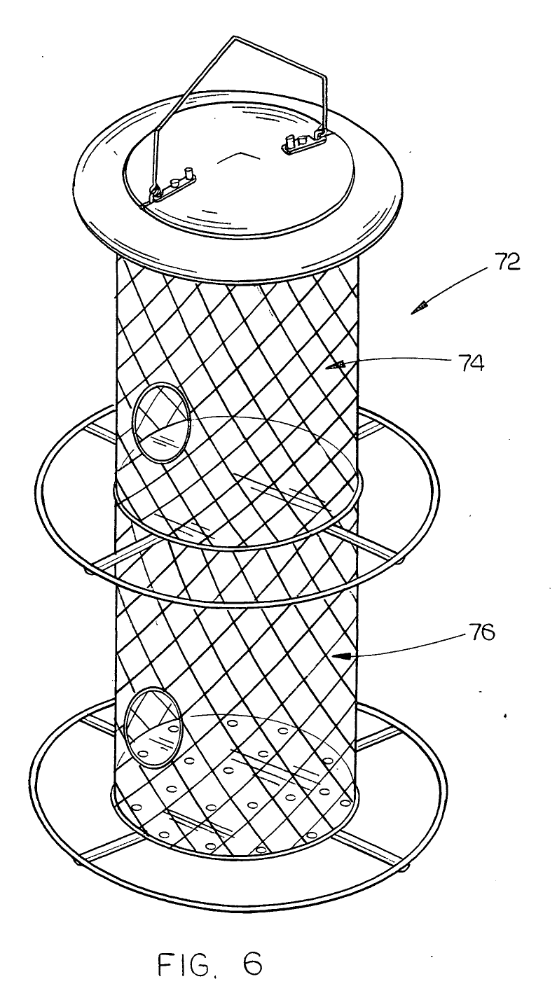

FIG. 6 illustrates a further embodiment of the bird house of this invention which is referred to generally by the reference numeral 72. Bird house 72 is identical to bird house 38 except that the upper metal mesh wall 74 is cylindrical in shape rather than the truncated, conical-shape upper mesh wall 40 of bird house 38. As seen in FIG. 6, the lower metal mesh wall 76 of bird house 72 is cylindrical in shape rather than the inverted, truncated conical shape of the lower mesh wall 42 of bird house 38.

Thus it can be seen that novel bird houses have been provided which are collapsible so as to occupy little space when in their collapsed shipping or storage position. The fact that the bird houses are constructed of the metal mesh material enables the same to be easily cleaned with a garden hose or inserted into a dishwasher or the like. The metal construction of the bird houses is durable in use and resistant to squirrel damage or the like.

Thus it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A collapsible bird house, comprising:
a truncated, conical-shaped, collapsible mesh wall having upper and lower ends;
said collapsible mesh wall having a bird access opening formed therein above the lower end thereof to permit birds to pass therethrough to gain access to the interior of said collapsible mesh wall;
a lower disc-shaped support plate secured to said collapsible mesh wall which extends across the lower end thereof;
a cover secured to said collapsible mesh wall at the upper end thereof;
and a hanger member at the upper end of said collapsible mesh wall for hanging the bird house from a support.

2. The collapsible bird house of claim 1 wherein said collapsible mesh wall is comprised of a metal material.

3. The collapsible bird house of claim 1 wherein said lower disc-shaped support plate is perforated.

4. The collapsible bird house of claim 1 wherein said collapsible mesh wall defines diamond-shaped openings which are large enough to permit a person to view bird activity within the interior of the bird house.

5. The collapsible bird house of claim 1 wherein a perch ring is secured to said collapsible mesh wall below said bird access opening.

6. The collapsible bird house of claim 1 wherein said cover is selectively removably secured to said collapsible mesh wall.

7. The collapsible bird house of claim 1 wherein said hanger member is pivotally secured to said collapsible mesh wall.

8. A multi-level collapsible bird house, comprising:
a lower collapsible mesh wall having upper and lower ends;
a disc-shaped support plate secured to said lower collapsible mesh wall which extends across the lower end thereof;
an upper collapsible mesh wall having upper and lower ends;
said lower end of said upper collapsible mesh being joined to said upper end of said lower collapsible mesh wall;
an intermediate disc-shaped support plate positioned between said upper end of said lower collapsible mesh wall and said lower end of said upper collapsible mesh wall to define upper and lower bird house portions;
a cover secured to said upper collapsible mesh wall at the upper end thereof;
said lower collapsible mesh wall having a first bird access opening formed therein between said lower and intermediate support plates to permit birds to pass therethrough to gain access to the interior of said lower bird house portion;
said upper collapsible mesh wall having a bird access opening formed therein between said intermediate support plate and said cover to permit birds to pass therethrough to gain access to the interior of said upper bird house portion;
and a hanger member at the upper end of said upper collapsible mesh wall for supporting the bird house from a support.

9. The collapsible bird house of claim 8 wherein said collapsible mesh walls are comprised of a metal material.

10. The collapsible bird house of claim 8 wherein said lower disc-shaped support plate is perforated.

11. The collapsible bird house of claim 8 wherein said collapsible mesh walls define diamond-shaped openings which are large enough to permit a person to view bird activity within the bird house.

12. The collapsible bird house of claim 8 wherein a first perch ring is secured to said lower collapsible mesh wall below said first bird access opening and wherein a second perch ring is secured to said upper collapsible mesh wall below said second bird access opening.

13. The multi-level collapsible bird house of claim 8 wherein said lower mesh wall has an inverted, truncated conical shape and wherein said upper mesh wall has a truncated conical shape.

14. A collapsible bird house, comprising:
a generally cylindrical-shaped collapsible mesh wall having upper and lower ends;
said collapsible mesh wall having a bird access opening formed therein above the lower end thereof to permit birds to pass therethrough to gain access to the interior of said collapsible mesh wall;
a lower disc-shaped support plate secured to said collapsible mesh wall which extends across the lower end thereof;
a cover secured to said collapsible mesh wall at the upper end thereof;
and a hanger member at the upper end of said collapsible mesh wall for hanging the bird house from a support.

15. The collapsible bird house of claim 14 wherein said collapsible mesh wall is comprised of a metal material.

16. The collapsible bird house of claim 14 wherein said lower disc-shaped support plate is perforated.

17. The collapsible bird house of claim 14 wherein said collapsible mesh wall defines diamond-shaped openings which are large enough to permit a person to view bird activity within the interior of the bird house.

18. The collapsible bird house of claim 14 wherein a perch ring is secured to said collapsible mesh wall below said bird access opening.

19. The collapsible bird house of claim 14 wherein said cover is selectively removably secured to said collapsible mesh wall.

20. A multi-level collapsible bird house, comprising:
a generally cylindrical-shaped collapsible mesh wall having upper and lower ends;
a lower disc-shaped support plate secured to said collapsible mesh wall which extends across the lower end thereof;
an intermediate disc-shaped support plate positioned within said collapsible mesh wall and secured thereto above said lower disc-shaped support plate which defines a lower bird house portion between said lower support plate and said intermediate support plate;
a cover secured to said collapsible mesh wall at the upper end thereof which defines an upper bird house portion between said intermediate support plate and said cover;
said collapsible mesh wall having a first bird access opening formed therein between said lower and intermediate support plates to permit birds to pass therethrough to gain access to the interior of said lower bird house portion;
said collapsible mesh wall having a second bird access opening formed therein between said intermediate support plate and said cover to permit birds to pass therethrough to gain access to the interior of said upper bird house portion;
and a hanger member at the upper end of said collapsible mesh wall for supporting said collapsible mesh wall from a support.

21. The collapsible bird house of claim 20 wherein said collapsible mesh wall defines diamond-shaped openings which are large enough to permit a person to view bird activity within the bird house.
